(19) United States
(12) Patent Application Publication
(10) Pub. No.: US 2018/0166956 A1
(43) Pub. Date: Jun. 14, 2018

(54) STATOR MANUFACTURING APPARATUS AND STATOR MANUFACTURING METHOD

(71) Applicant: TOYOTA JIDOSHA KABUSHIKI KAISHA, Toyota-shi (JP)

(72) Inventor: Yutaka SENO, Okazaki-shi (JP)

(73) Assignee: TOYOTA JIDOSHA KABUSHIKI KAISHA, Toyota-shi (JP)

(21) Appl. No.: 15/837,424

(22) Filed: Dec. 11, 2017

(30) Foreign Application Priority Data
Dec. 14, 2016 (JP) 2016-241974

(51) Int. Cl. H02K 15/06; H02K 15/04

(52) U.S. Cl. CPC H02K 15/062; H02K 15/085; H02K 15/0435

(57) ABSTRACT

A stator manufacturing apparatus includes: an insert piece having such a stepped structure that a width of the insert piece increases along a winding axis direction of a coil from a side to be fitted into the coil, fitted into the coil, configured to maintain an inside width of the coil; and an insert piece driving unit configured to move the insert piece along the winding axis direction of the coil.

### INCORPORATION BY REFERENCE

The disclosure of Japanese Patent Application No. 2016-241974 filed on Dec. 14, 2016 including the specification, drawings and abstract is incorporated herein by reference in its entirety.

### BACKGROUND

### 1. Technical Field

The present disclosure relates to a stator manufacturing apparatus and a stator manufacturing method for installing a coil of concentrated winding to a tooth of a stator core.

### 2. Description of Related Art

Motors and electric generators use a stator having teeth on each of which a coil that is a winding of a conductor is mounted. Recently, there has been a growing demand for increasing the efficiency and reducing the size and weight of motors, and meeting this demand requires increasing the space factor of a conductor in the slots of the stator.

Japanese Patent Application Publications No. 2012-257410, No. 2015-33146, and No. 2016-123211 disclose motor stator manufacturing apparatuses for mounting a trapezoidal coil to a tooth tapered toward a tip in a stator core that is a cylindrical member having a plurality of such teeth formed on the inner circumference. These apparatuses employ a technique of deforming a trapezoidal coil into an oblique deformed shape and mounting the coil in this state to a tooth so as not to interfere with other teeth or other coils that are already mounted.

If the inside width of the coil is reduced while the coil is mounted to the tooth by this technique, the coil may fail to be correctly mounted to the tooth, or an insulating coating on the coil etc. may be damaged as the coil interferes with the tooth during mounting. Especially when a coil deformed into an oblique deformed shape is mounted to a tooth, the inside width of the coil is highly likely to be reduced. To limit such a change in the inside width of the coil, a configuration has been hitherto adopted in which a member (insert piece) having a width slightly smaller than the width of the coil is inserted into the coil.

### SUMMARY

Motors and electric generators use stators of various sizes, and coils to be mounted also vary in size according to the size of the teeth of the stator core. On the other hand, it is desirable, from the viewpoint of reducing equipment investment and securing an installation place, to be able to mount coils of a plurality of sizes having different inside widths by one stator manufacturing apparatus.

The present disclosure is a stator manufacturing apparatus and a stator manufacturing method that can handle coils having different inside widths.

One aspect of the present disclosure includes a stator manufacturing apparatus for installing a coil of concentrated winding to a tooth of a stator core. The stator manufacturing apparatus includes: an insert piece having such a stepped structure that a width of the insert piece increases along a winding axis direction of the coil from a side to be fitted into the coil, fitted into the coil, configured to maintain an inside width of the coil; and an insert piece driving unit configured to move the insert piece along the winding axis direction of the coil. One aspect of the present disclosure includes a stator manufacturing method using a stator manufacturing apparatus for installing a coil of concentrated winding to a tooth of a stator core. The stator manufacturing apparatus includes an insert piece having such a stepped structure that a width of the insert piece increases along a winding axis direction of the coil from a side to be fitted into the coil, fitted into the coil, configured to maintain an inside width of the coil, an insert piece driving unit configured to move the insert piece along the winding axis direction of the coil, an insert piece driving unit configured to move the insert piece along the winding axis direction of the coil, a rotation driving unit, a coil deforming mechanism configured to deform the coil by moving a front side portion of the coil that is a portion to be mounted first to the tooth and a back side portion of the coil that is a portion to be mounted last to the tooth, relative to each other in a direction of the inside width of the coil, and a stroke driving unit. The stator manufacturing method includes: (i) mounting the coil on the stator manufacturing apparatus such that a tip of the tooth and a front side of the coil face each other; (ii) shifting relative positions of the coil deforming mechanism and the coil in a circumferential direction, deforming the coil so that a maximum width of the coil is smaller than a center-to-center width of slots into which the coil is to be inserted; (iii) rotating the coil by the rotation driving unit so that an orientation of the coil matches a shape of openings of the slots into which the coil is to be inserted; (iv) moving the coil toward the tooth by the stroke driving unit while maintaining the coil in an oblique shape; (v) adjusting a rotation angle of the coil by the rotation driving unit so that the coil faces a front side of the tooth, inserting the coil into the slots while changing the relative positions of the coil deforming mechanism and the coil; and (vi) unclamping the coil from the coil deforming mechanism installing the coil to the tooth.

The insert piece may be fitted into the coil from a back side portion of the coil that is a portion of the coil to be mounted last to the tooth, and the insert piece driving unit may include an elastic body that urges the insert piece from the back side portion of the coil toward a front side portion of the coil that is a portion to be mounted first to the tooth.

The stator manufacturing apparatus may further include a coil deforming mechanism configured to deform the coil by moving a front side portion of the coil that is a portion to be mounted first to the tooth and a back side portion of the coil that is a portion to be mounted last to the tooth, relative to each other in a direction of the inside width of the coil.

According to the present disclosure, it is possible to install a plurality of types of coils having different sizes to a stator core while maintaining the inside width of each coil.

A length of the insert piece in a center axis direction of the stator core may be shorter than a shortest inside length in the axis direction of a plurality of types of coils to be installed.

According to the present disclosure, the inside width of the coil can be maintained to be constant to a large extent in the center axis direction. Moreover, the insert piece having such a length can be fitted into all the coils to be installed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view showing an example of the configuration of a stator in an embodiment of the present disclosure;

FIG. 2 is a plan view showing the example of the configuration of the stator in the embodiment of the present disclosure;

FIG. 3A is a view showing an example of a coil;

FIG. 3B is a view showing another example of the coil;

FIG. 4 is an external perspective view showing the configuration of a stator manufacturing apparatus in the embodiment of the present disclosure;

FIG. 5 is an external side view showing the configuration of the stator manufacturing apparatus in the embodiment of the present disclosure;

FIG. 6 is an external front view showing the configuration of the stator manufacturing apparatus in the embodiment of the present disclosure;

FIG. 7 is an external perspective view showing the configuration of the stator manufacturing apparatus with the coil mounted thereon in the embodiment of the present disclosure;

FIG. 8 is an external side view showing the configuration of the stator manufacturing apparatus with the coil mounted thereon in the embodiment of the present disclosure;

FIG. 9 is a view illustrating a relation between a stator core and the coil when coils on both sides of that coil are installed;

FIG. 10 is a view illustrating a relation between the stator core and the coil when the coil is deformed in an oblique shape;

FIG. 11 is a view showing the configuration of insert pieces in the embodiment of the present disclosure;

FIG. 12 is a view showing a state where the insert pieces in the embodiment of the present disclosure are mounted in a coil intended for a small-diameter core;

FIG. 13 is a view showing a state where the insert pieces in the embodiment of the present disclosure are mounted in a coil intended for a large-diameter core;

FIG. 14 is a view showing the configuration of another example of the insert piece in the embodiment of the present disclosure;

FIG. 15 is a view illustrating a coil installation process in the embodiment of the present disclosure;

FIG. 16 is a view illustrating the coil installation process (first step) in the embodiment of the present disclosure;

FIG. 17 is a view illustrating the coil installation process (second step) in the embodiment of the present disclosure;

FIG. 18 is a view illustrating the coil installation process (third step) in the embodiment of the present disclosure; and

FIG. 19 is a view illustrating the coil installation process (fourth step) in the embodiment of the present disclosure.

### DETAILED DESCRIPTION OF EMBODIMENTS

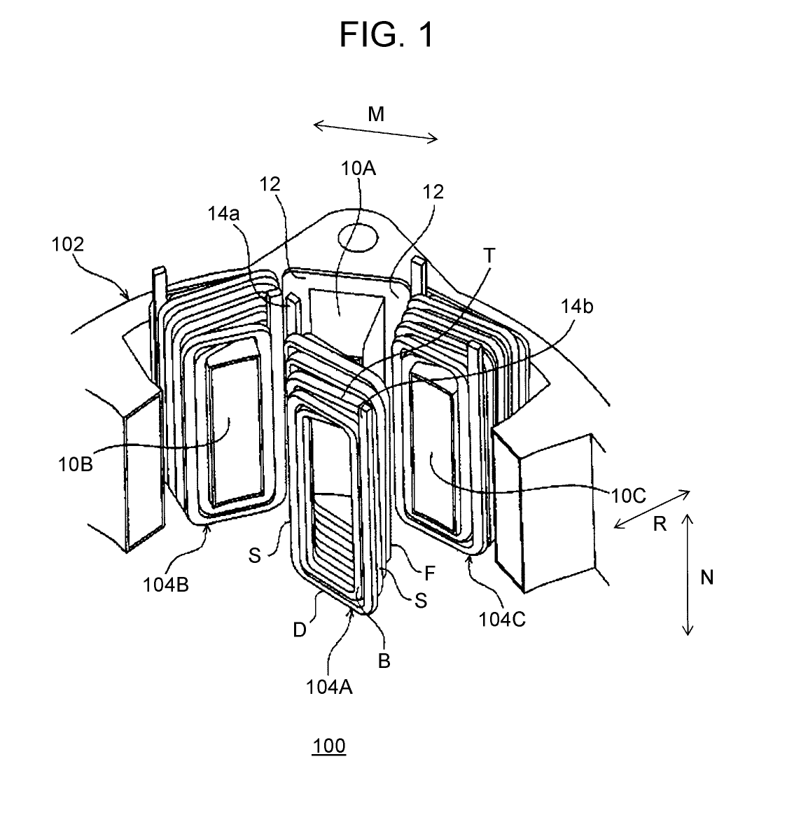

As shown in FIG. 1, a stator 100 has a configuration in which coils 104 are installed on a stator core 102. FIG. 1 is a perspective view showing the external appearance of a segment of the stator 100 that is partially cut out. For the convenience of depiction, the coils 104 are shown with a reduced number of winding turns in FIG. 1.

The stator core 102 is a cylindrical member that is provided on an inner circumference of the stator 100 and has a plurality of teeth 10 (a first tooth 10A, a second tooth 10B, and a third tooth 10C) protruding in a radial direction R. The stator core 102 can be formed by stacking hollow disc-shaped metal plates along a center axis direction N (height direction). A plurality of teeth 10 are provided at predetermined intervals along a circumferential direction M (width direction) of the stator core 102. In this embodiment, the teeth 10 each have a shape of which the width along the circumferential direction M of the stator core 102 decreases toward a tip of the tooth 10. Each clearance between the adjacent teeth 10 forms a slot 12. The slot 12 is a space housing the coil 104 that is mounted so as to be wound around the tooth 10.

The coils 104 (a first coil 104A, a second coil 104B, and a third coil 104C) are coils of concentrated winding that are formed by winding a conductive wire into a spiral shape. For example, the coil 104 can be formed by winding one flat conductor having a rectangular cross-sectional shape in two layers of an inner and an outer layers, and thus winding the flat conductor into a spiral shape along a winding axis direction. For example, the flat conductor is composed of a highly electrically conductive metal, such as copper, and is surrounded by an insulating coating. Ends of the coil 104 are led out from the coil 104 as lead portions 14a, 14b.

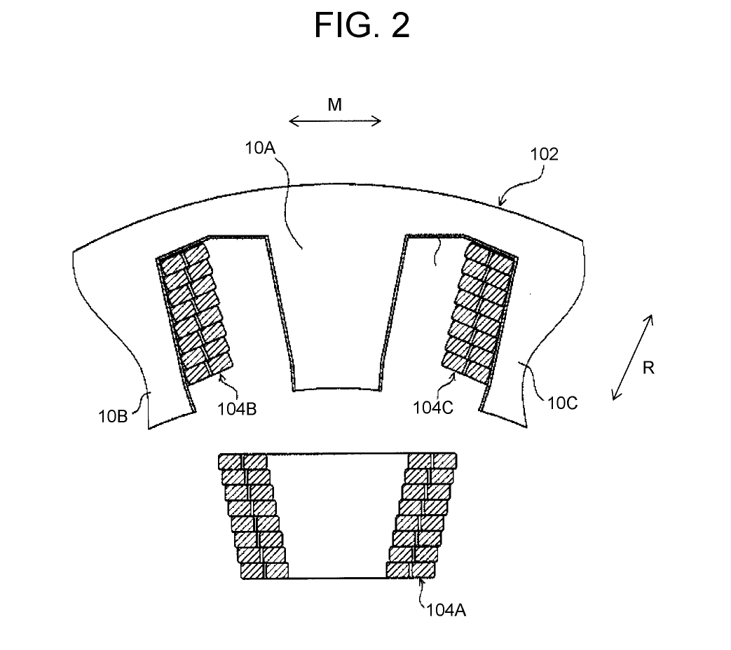

The coil 104 is shaped so as to match the shape of the tooth 10 of the stator core 102. In this embodiment, as shown in FIG. 2, the cross-section of the coil 104 orthogonal to the center axis direction N of the stator core 102 has a trapezoidal shape.

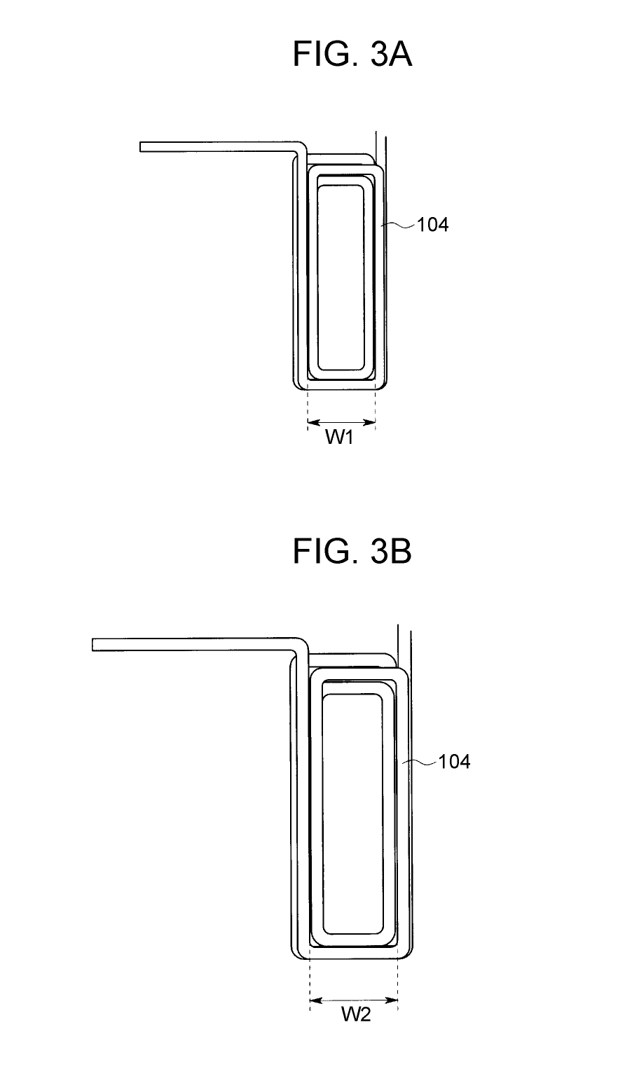

As shown in FIG. 3A and FIG. 3B, the coils 104 are formed in various sizes according to the size of the teeth 10. The coil 104 of FIG. 3A is intended for a small-diameter core and has an inside width W1. The coil 104 of FIG. 3B is intended for a large-diameter core and has an inside width W2, which is larger than the width W1.

In the description of this embodiment, the names of parts of the coil 104 are defined as follows. A side of the coil 104 to be inserted first into the slots 12 will be referred to as a front side F, and a side thereof to be inserted last into the slots 12 will be referred to as a back side B. Thus, the coil 104 is mounted on the tooth 10 so that the front side F is on a far side of the slots 12 and the back side B is on a near side of the slots 12. One side of the coil 104 and the other side thereof along the center axis direction N (height direction) of the stator core 102 will be referred to as an upper side T and a lower side D, respectively. Parts connecting the upper side T and the lower side D to each other will be referred to as lateral sides S.

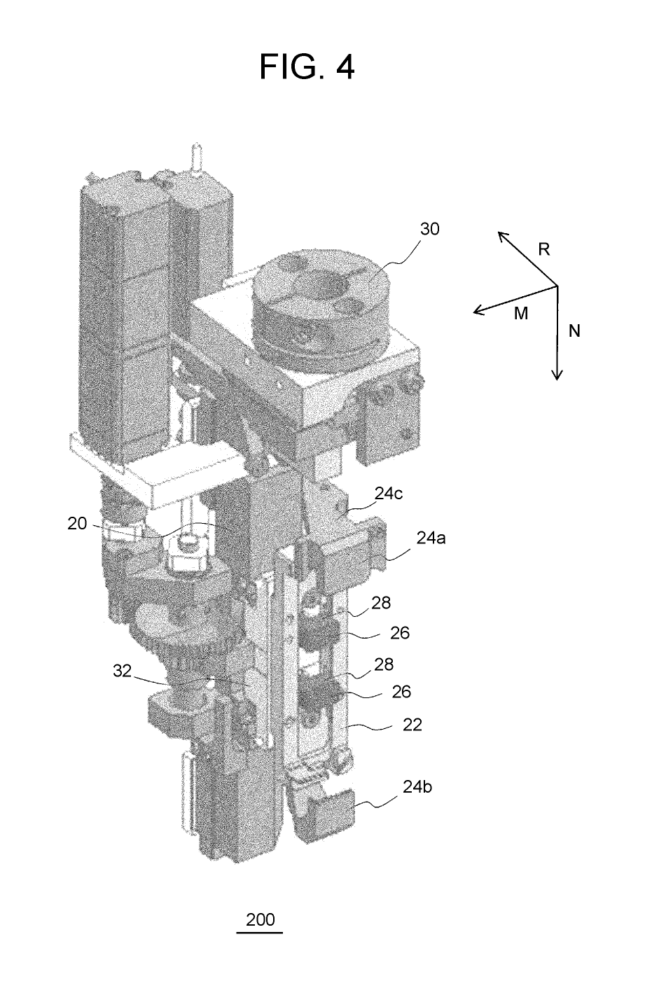

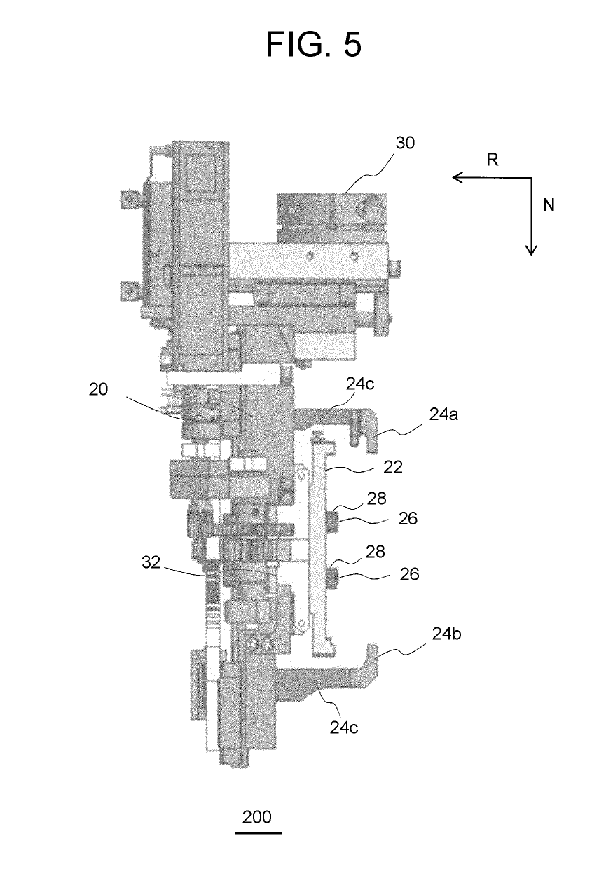

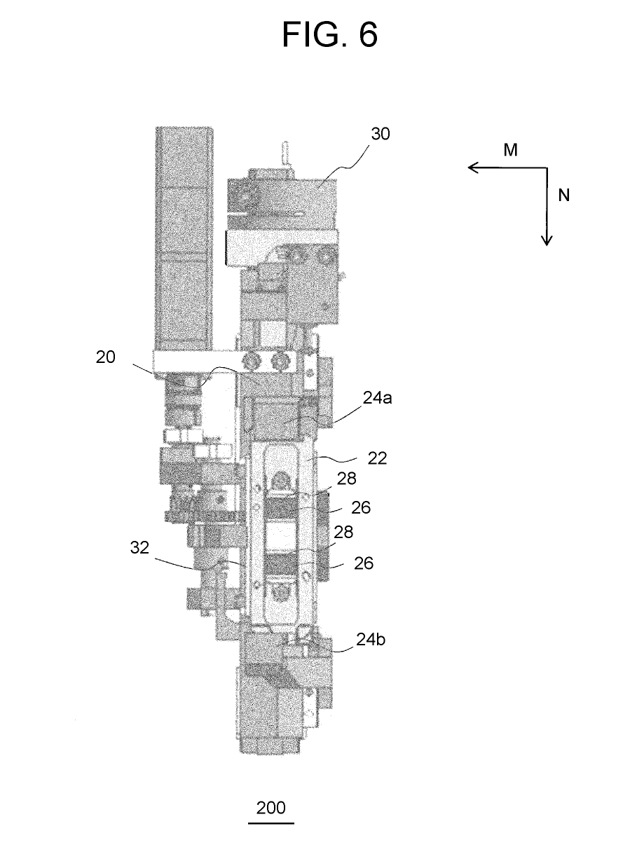

As shown in FIG. 4 to FIG. 6, a stator manufacturing apparatus 200 in the embodiment of the present disclosure includes a hand main body 20, a coil support unit 22, a clamp 24 (24a, 24b), insert pieces 26, insert piece driving units 28, a rotation driving unit 30, and a stroke driving unit 32. Here, FIG. 4 is an external perspective view of the stator manufacturing apparatus 200; FIG. 5 is an external side view of the stator manufacturing apparatus 200; and FIG. 6 is an external front view of the stator manufacturing apparatus 200.

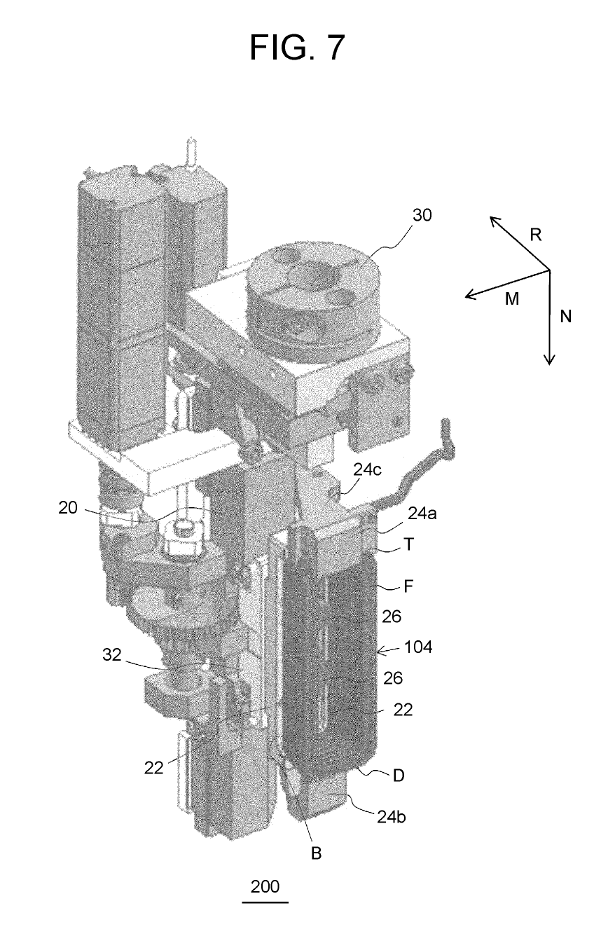

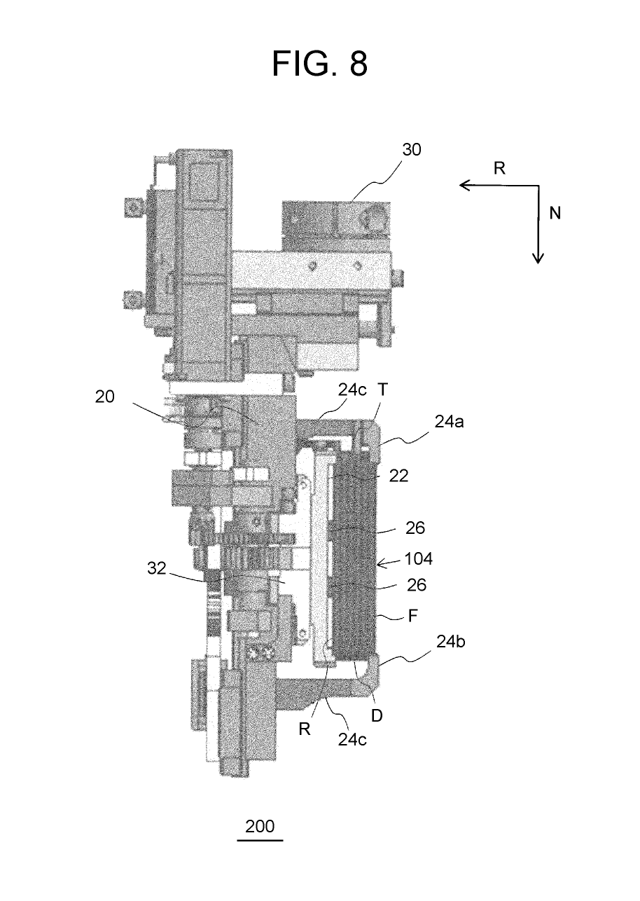

The stator manufacturing apparatus 200 is an apparatus that installs the coil 104 to the tooth 10 by clamping the coil 104 with the coil support unit 22 and the clamp 24 and inserting the coil 104 into the slots 12. FIG. 7 and FIG. 8 are respectively an external perspective view and an external side view of the stator manufacturing apparatus 200 with the coil 104 mounted thereon.

The hand main body 20 is a member that structurally support the coil support unit 22, the clamp 24 (24a, 24b), the insert pieces 26, the insert piece driving units 28, the rotation driving unit 30, and the stroke driving unit 32. The stator manufacturing apparatus 200 is inserted into the stator core 102 and installs the coil 104 in this state. Therefore, the hand main body 20 is formed as a rod-shaped member extending along the center axis direction N of the stator core 102.

The coil 104 is clamped by being held between the coil support unit 22 and the clamp 24. The clamp 24 has a first clamp claw 24a that clamps the coil 104 from the upper side T and a second clamp claw 24b that clamps the coil 104 from the lower side D. The first clamp claw 24a and the second clamp claw 24b can be driven by a clamp driving unit 24c along the radial direction R and the circumferential direction M of the stator core 102. The coil support unit 22 is a member that is disposed so as to face the first clamp claw 24a.

To set the coil 104 in the stator manufacturing apparatus 200, the coil 104 is disposed between the coil support unit 22 and the clamp 24. Here, the coil 104 is disposed so that the lateral sides S thereof are oriented along the center axis direction N of the stator core 102. With a tip of the first clamp claw 24a in contact with the front side F of the coil 104 closer to the upper side T, and with a tip of the second clamp claw 24b in contact with the front side F of the coil 104 closer to the lower side D, the clamp 24 is moved toward the coil support unit 22 by the clamp driving unit 24c. As a result, the first clamp claw 24a and the second clamp claw 24b are pressed to the front side F of the coil 104, while the back side B of the coil 104 is pressed against the coil support unit 22. Thus, the coil 104 is clamped by being held between the clamp 24 and the coil support unit 22.

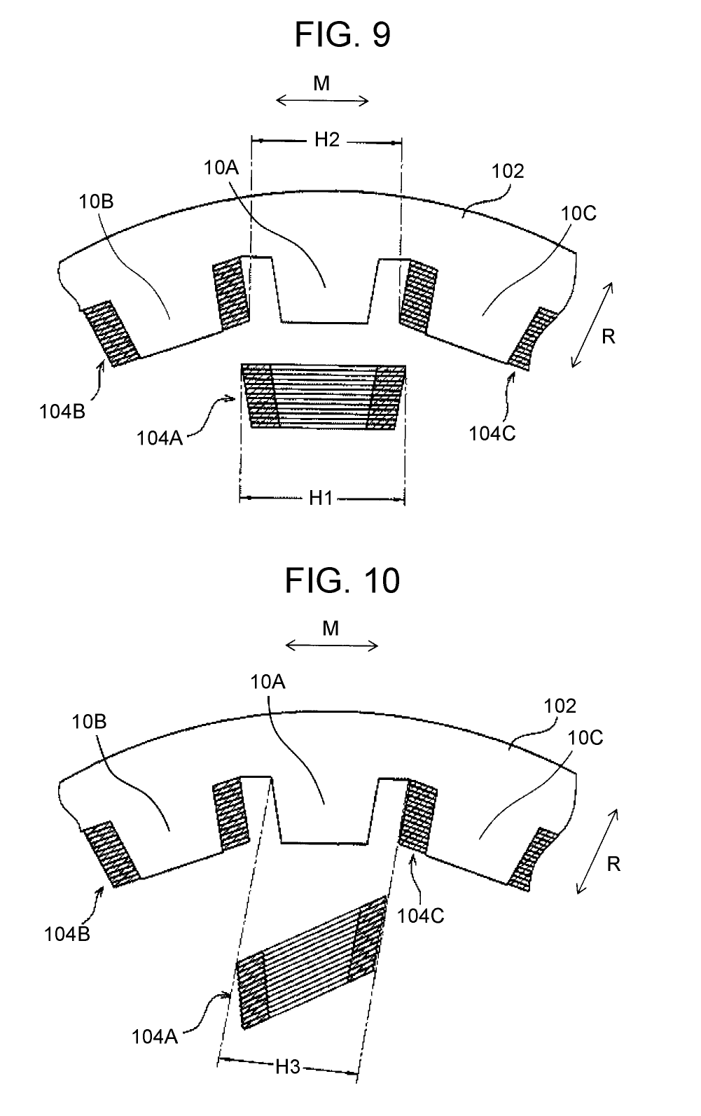

As shown in FIG. 9, in the case where the second coil 104B and the third coil 104C are already respectively mounted on the second tooth 10B and the third tooth 10C on both sides of the first tooth 10A, an attempt to mount the first coil 104A to the first tooth 10A between the second tooth 10B and the third tooth 10C fails due to a maximum outside diameter H1 of the first coil 104A being larger than a center-to-center width H2 of the slots 12. It is therefore necessary to mount the first coil 104A by deforming the first coil 104A so that the maximum outside diameter H3 thereof becomes smaller than the center-to-center width H2 of the slots 12 as shown in FIG. 10.

In the stator manufacturing apparatus 200, the first clamp claw 24a and the second clamp claw 24b can be moved by the clamp driving unit 24c along the circumferential direction M of the stator core 102. Moving the first clamp claw 24a and the second clamp claw 24b relative to the coil support unit 22 along the circumferential direction M can deform the coil 104 (104A) into a desired shape as shown in FIG. 10 (hereinafter referred to as an oblique shape). Thus, the coil support unit 22 and the clamp 24 function as coil deforming means (coil deforming mechanism) that deforms the coil 104 into an oblique shape.

The stator manufacturing apparatus 200 further includes the insert pieces 26 and the insert piece driving units 28. The insert piece 26 is a member that is fitted into the coil 104 to maintain the inside width of the coil 104.

As shown in FIG. 4 to FIG. 6, the insert pieces 26 are provided at such a position that the insert pieces 26 are fitted into the coil 104 from the back side B of the coil 104. For example, the insert pieces 26 are provided at a center part of the coil support unit 22.

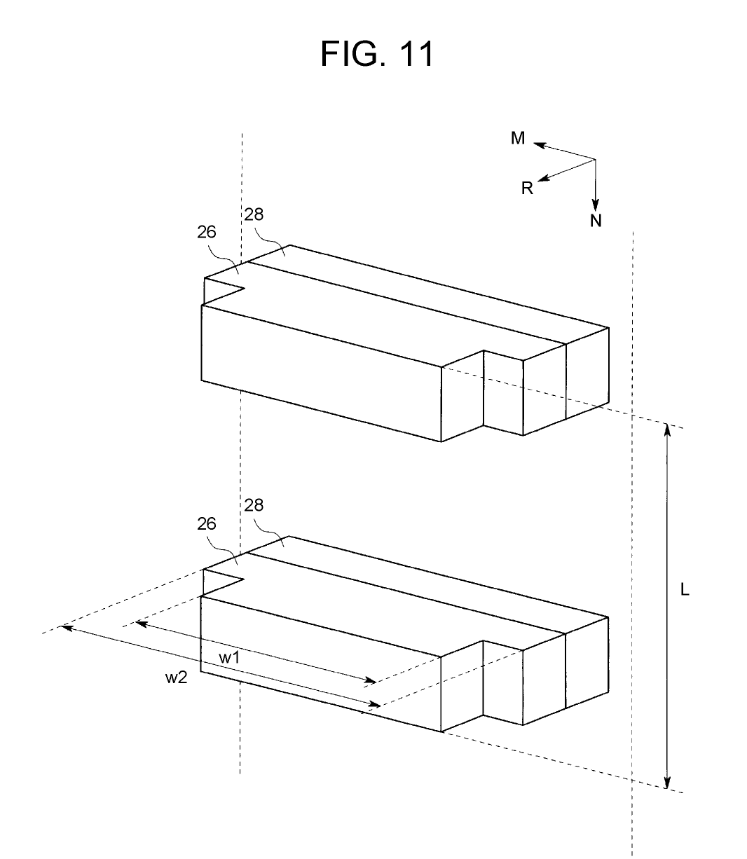

FIG. 11 shows an example of the configuration of the insert pieces 26. In FIG. 11, to clarify the configuration of the insert pieces 26, members other than the insert pieces 26 and the insert piece driving units 28 are conveniently omitted.

In this embodiment, the insert piece 26 has such a stepped structure that the width of the insert piece 26 increases stepwise from a side to be fitted into the coil 104, along the winding axis direction of the coil 104 as mounted on the stator 100, i.e., along the radial direction R of the stator core 102. For example, in FIG. 11, the insert piece 26 has such a stepped structure that the insert piece 26 has a width w1 and a width w2 from a leading end side in the radial direction R. For example, the height of the step is preferably not smaller than half the width of the conductive wire of the coil 104 to be installed.

The insert piece 26 can be moved by the insert piece driving unit 28 in the radial direction R. The insert piece driving unit 28 can be configured to urge the insert piece 26 in the radial direction R by an elastic body. For example, the insert piece driving unit 28 can include an elastic body, such as a spring or a rubber. The insert piece driving unit 28 may be configured to move the insert piece 26 in the radial direction R through a mechanical or an electric action.

When the coil 104 is clamped by the clamp 24, the coil 104 is pressed against the insert pieces 26 in the radial direction R. Meanwhile, the insert pieces 26 are urged by the insert piece driving units 28 in a direction opposite from the direction in which the coil 104 is pressed by the clamp 24, so that the insert pieces 26 are fitted into the coil 104.

In the case where the coils 104 having different sizes as shown in FIG. 3A and FIG. 3B are to be installed, the width w1 of the insert piece 26 is set to be slightly smaller than the inside width W1 of the coil 104 shown in FIG. 3A, and the width w2 of the insert piece 26 is set to be slightly smaller than the inside width W2 of the coil 104 shown in FIG. 3B.

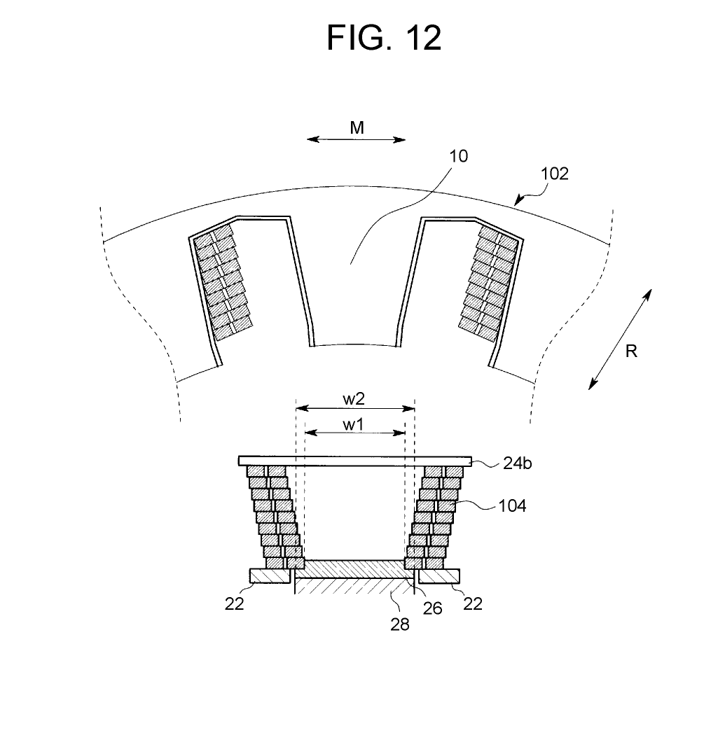

If the width w2 of the insert piece 26 is set to be larger than the inside width W1 of the coil 104 of FIG. 3A, a portion of the insert piece 26 having the width w2 is not fitted into the coil 104 when the insert piece 26 is fitted into the coil 104 as shown in FIG. 12. Accordingly, when the coil 104 is held between the coil support unit 22 and the clamp 24, by the action of the insert piece driving unit 28, the insert piece 26 recedes in the radial direction R for the thickness of the portion having the width w2, while only a portion of the insert piece 26 having the width w1 is fitted into a portion of the coil 104 having the inside width W1. Here, since the width w1 of the insert piece 26 is set to be slightly smaller than the inside width W1 of the coil 104, a change in the inside width W1 due to deformation of the coil 104 etc. can be prevented. In other words, the inside width W1 of the coil 104 can be maintained to be constant.

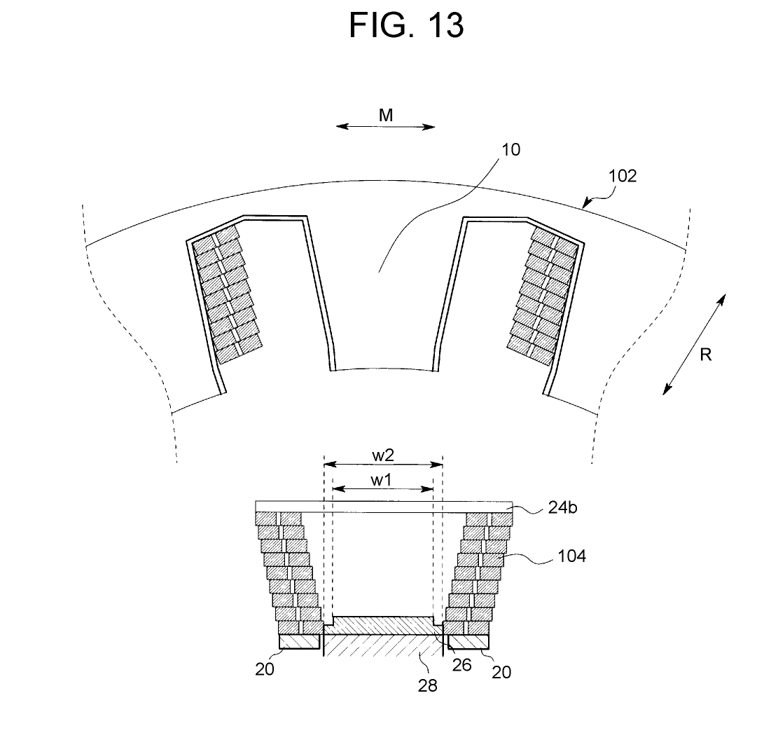

When the insert piece 26 is fitted into the coil 104 of FIG. 3B, the portion of the insert piece 26 having the width w2 is fitted into a portion of the coil 104 having the inside width W2 as shown in FIG. 13. Since the width w2 of the insert piece 26 is set to be slightly smaller than the inside width W2 of the coil 104, a change in the inside width W2 due to deformation of the coil 104 etc. can be prevented. In other words, the inside width W2 of the coil 104 can be maintained to be constant.

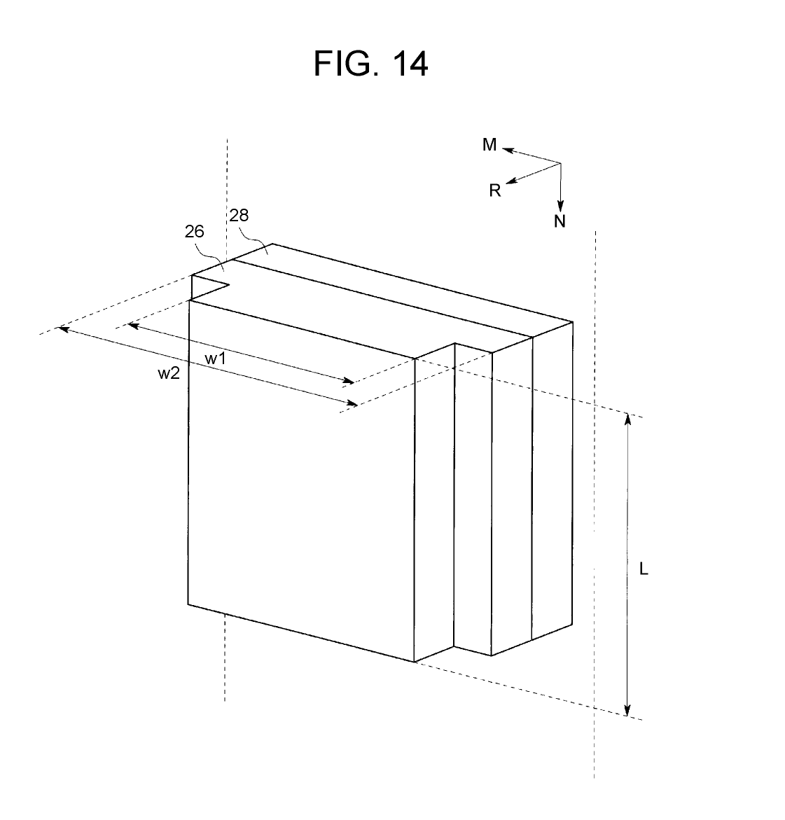

It is preferable that a plurality of insert pieces 26 be provided in a line in the center axis direction N of the stator core 102 as shown in FIG. 11. Alternatively, it is also preferable that the insert piece 26 have a shape that is long in the center axis direction N as shown in FIG. 14. Thus, the inside width of the coil 104 can be maintained to be constant to a large extent in the center axis direction N. However, a length L of the insert piece 26 in the center axis direction N should be shorter than a shortest inside length in the center axis direction N of the plurality of types of coils 104 to be installed. The insert piece 26 having such a length L can be fitted into all the coils 104 to be installed.

In the following, an installation process of the coil 104 using the stator manufacturing apparatus 200 will be described. First, an installation process in the case where other coils 104 are not yet mounted on other teeth 10 on both sides of the tooth 10 to which the coil 104 is to be installed will be described.

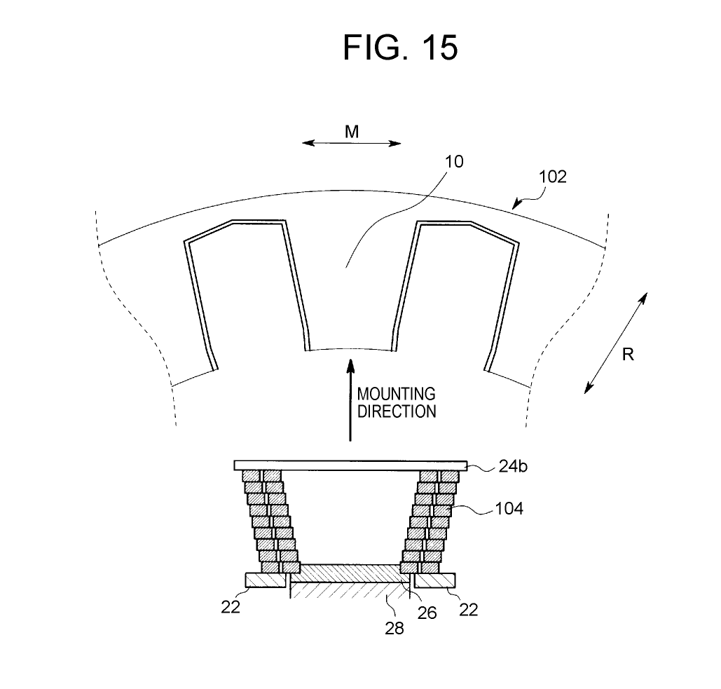

The coil 104 is mounted on the stator manufacturing apparatus 200 as shown in FIG. 7 and FIG. 8. Then, the hand main body 20 is inserted into the stator core 102, and the hand main body 20 is rotated by the rotation driving unit 30 so that the tip of the tooth 10 to which the coil 104 is to be installed and the front side F of the coil 104 face each other as shown in FIG. 15. Then, the coil 104 is moved by the stroke driving unit 32 toward the tooth 10 along the radial direction R of the stator core 102 (the mounting direction indicated by the arrow in FIG. 15) while a state where the coil 104 is clamped by the coil support unit 22 and the clamp 24 is maintained. Thus, the coil 104 is installed to the tooth 10.

The coil 104 intended for a large-size core shown in FIG. 3B can be mounted by the same installation process.

Next, an installation process in the case where another coil 104 is already mounted on at least one of the teeth 10 on both sides of the tooth 10 to which the coil 104 is to be installed will be described. In the following description, the case where the coils 104 are already respectively mounted on the teeth 10 on both sides of the tooth 10 to which the coil 104 is to be installed will be described, but the same process can be used also when the coil 104 is mounted on only one of the teeth 10 on both sides.

In this case, too, first, the coil 104 is mounted on the stator manufacturing apparatus 200 as shown in FIG. 7 and FIG. 8 so that the tip of the tooth 10 to which the coil 104 is to be installed and the front side F of the coil 104 face each other. Then, the coil 104 is installed by the following steps.

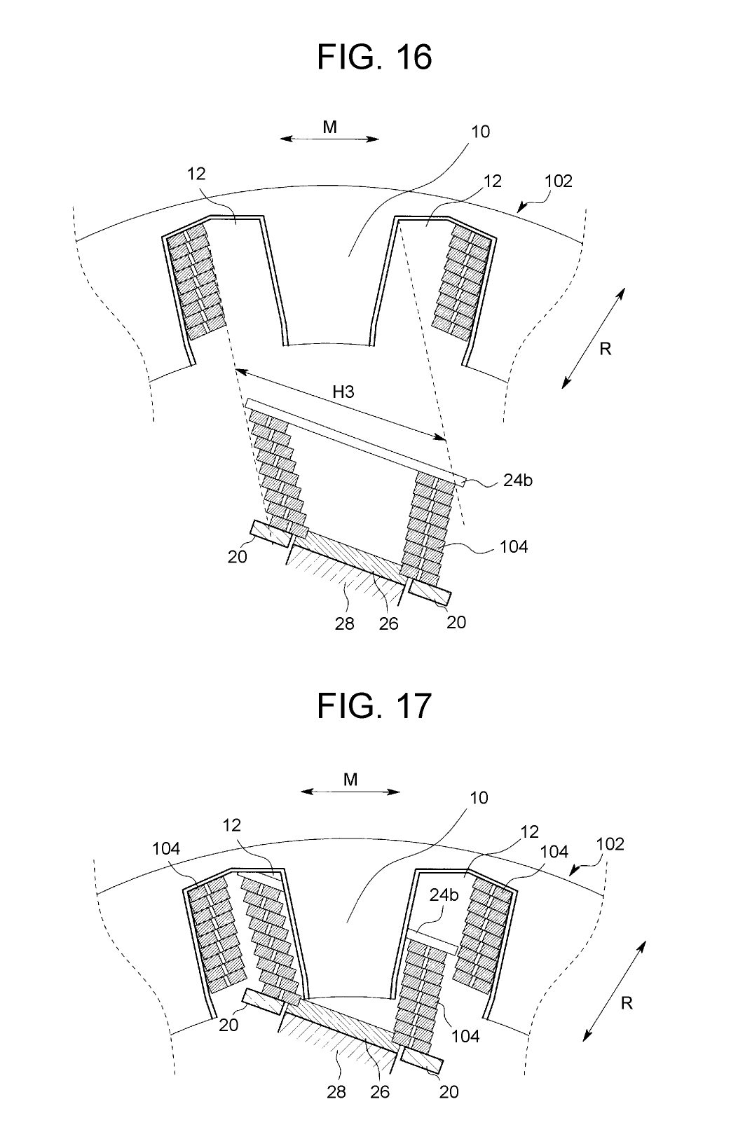

The relative positions of the coil support unit 22 and the clamp 24 are shifted in the circumferential direction M to thereby deform the coil 104 into an oblique shape as shown in FIG. 16. Here, the coil 104 is deformed so that the maximum width H3 of the coil 104 becomes smaller than the center-to-center width of the slots 12 into which the coil 104 is to be inserted. At the same time as the coil 104 is thus deformed, the coil 104 is rotated by the rotation driving unit 30 so that the orientation of the coil 104 matches the shape of openings of the slots 12.

While the coil 104 is maintained in the oblique shape, the coil 104 is moved toward the tooth 10 by the stroke driving unit 32 as shown in FIG. 17. Since the coil 104 is maintained in the oblique shape, the coil 104 can be inserted into the slots 12 without hitting the other coils 104 that are already mounted.

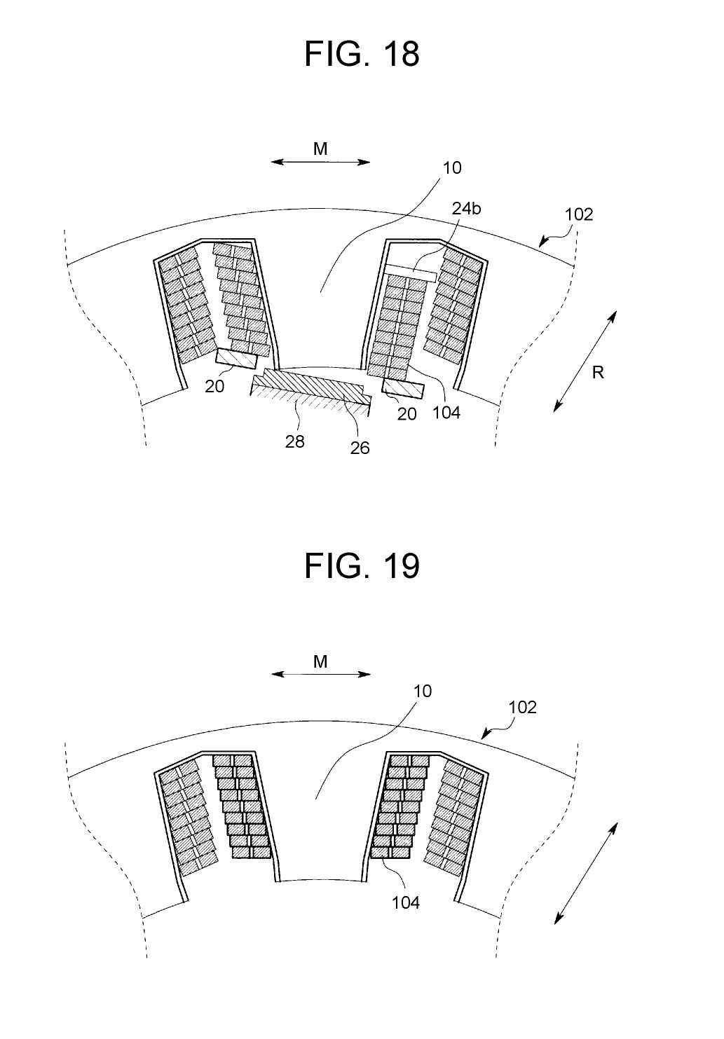

As shown in FIG. 18, the rotation angle of the coil 104 is adjusted by the rotation driving unit 30 so that the coil 104 faces a front side of the tooth 10, and the coil 104 is inserted further into the slots 12 while the relative positions of the coil support unit 22 and the clamp 24 are changed so as to restore the coil 104 from the oblique shape to its original shape.

Here, when a surface of the insert piece 26 comes in contact with the tip of the tooth 10 as the coil 104 moves, the insert piece 26 is retracted by the insert piece driving unit 28 in a direction opposite from the moving direction of the coil 104 as shown in FIG. 18. However, once the insert pieces 26 are separated from the coil 104, the inside width of the coil 104 cannot be maintained. It is therefore preferable to install the coil 104 while restoring the coil 104 from deformation and adjusting the rotation angle of the coil 104 so that the coil 104 is not separated from the insert pieces 26 as far as possible.

Finally, the coil 104 is unclamped from the coil support unit 22 and the clamp 24, so that the coil 104 is fully restored to its original shape by an elastic force. Thus, the coil 104 is installed on the tooth 10 as shown in FIG. 19.

As has been described above, the coil 104 can be installed to the stator core 102 by using the stator manufacturing apparatus 200 of this embodiment. Moreover, the insert pieces 26 provided in this apparatus make it possible to install the coil 104 to the tooth 10 while maintaining the inside width of the coil 104 so as not to change the inside width during the installation process. Especially when the coil 104 is installed to the tooth 10 by being deformed into an oblique shape, a change in the inside width of the coil 104 due to the deformation can be suppressed.

The insert piece 26 has such a stepped structure that the width of the insert piece 26 increases stepwise, which allows the stator manufacturing apparatus 200 to install the plurality of types of coils 104 having different inside widths. Moreover, the insert piece 26 can be moved by the insert piece driving unit 28. Thus, it is possible to reliably fit the insert piece 26 inside the plurality of types of coils 104 having different sizes and thicknesses. In addition, it is possible to avoid a situation where the insert piece 26 and the tooth 10 come in contact with each other during installation of the coil 104 to the tooth 10 and pose an obstacle to the installation process.

The present disclosure is not limited to the above embodiment, but can be applied within a scope not departing from the gist of the disclosure.

For example, the number of the steps of the insert piece 26 is not limited to two, but may be three or more according to the number of the types of the coils 104 to be installed. Also when the insert piece 26 has a multi-step structure with three or more steps, the stepped structure should be such that the width of the insert piece 26 increases stepwise along the radial direction R from the side to be fitted into the coil 104.

What is claimed is:

1. A stator manufacturing apparatus for installing a coil of concentrated winding to a tooth of a stator core, the stator manufacturing apparatus comprising:
an insert piece having such a stepped structure that a width of the insert piece increases along a winding axis direction of the coil from a side to be fitted into the coil, fitted into the coil, configured to maintain an inside width of the coil; and
an insert piece driving unit configured to move the insert piece along the winding axis direction of the coil.

2. The stator manufacturing apparatus according to claim 1, wherein
the insert piece is fitted into the coil from a back side portion of the coil that is a portion of the coil to be mounted last to the tooth, and
the insert piece driving unit includes an elastic body that urges the insert piece from the back side portion of the coil toward a front side portion of the coil that is a portion to be mounted first to the tooth.

3. The stator manufacturing apparatus according to claim 1, further comprising a coil deforming mechanism configured to deform the coil by moving a front side portion of the coil that is a portion to be mounted first to the tooth and a back side portion of the coil that is a portion to be mounted last to the tooth, relative to each other in a direction of the inside width of the coil.

4. The stator manufacturing apparatus according to claim 1, wherein a length of the insert piece in a center axis direction of the stator core is shorter than a shortest inside length in the axis direction of a plurality of types of coils to be installed.

5. A stator manufacturing method using a stator manufacturing apparatus for installing a coil of concentrated winding to a tooth of a stator core,
the stator manufacturing apparatus including
an insert piece having such a stepped structure that a width of the insert piece increases along a winding axis direction of the coil from a side to be fitted into the coil, fitted into the coil, configured to maintain an inside width of the coil,
an insert piece driving unit configured to move the insert piece along the winding axis direction of the coil,
a rotation driving unit,
a coil deforming mechanism configured to deform the coil by moving a front side portion of the coil that is a portion to be mounted first to the tooth and a back side portion of the coil that is a portion to be mounted last to the tooth, relative to each other in a direction of the inside width of the coil, and
a stroke driving unit,
the stator manufacturing method comprising:
(i) mounting the coil on the stator manufacturing apparatus such that a tip of the tooth and a front side of the coil face each other;
(ii) shifting relative positions of the coil deforming mechanism and the coil in a circumferential direction, deforming the coil so that a maximum width of the coil is smaller than a center-to-center width of slots into which the coil is to be inserted;
(iii) rotating the coil by the rotation driving unit so that an orientation of the coil matches a shape of openings of the slots into which the coil is to be inserted;
(iv) moving the coil toward the tooth by the stroke driving unit while maintaining the coil in an oblique shape;
(v) adjusting a rotation angle of the coil by the rotation driving unit so that the coil faces a front side of the tooth, inserting the coil into the slots while changing the relative positions of the coil deforming mechanism and the coil; and
(vi) unclamping the coil from the coil deforming mechanism installing the coil to the tooth.
